(19) United States
(12) Patent Application Publication
(10) Pub. No.: US 2017/0222465 A1
(43) Pub. Date: Aug. 3, 2017

(54) DYNAMIC THERMAL BALANCING OF PARALLEL REGULATORS TO REDUCE HOTSPOTS AND INCREASE PERFORMANCE

(71) Applicant: QUALCOMM Incorporated, San Diego, CA (US)

(72) Inventors: Steve HAWLEY, Emerald Hills, CA (US); Christian SPORCK, Campbell, CA (US)

(21) Appl. No.: 15/260,272

(22) Filed: Sep. 8, 2016

Related U.S. Application Data
(60) Provisional application No. 62/289,891, filed on Feb. 1, 2016.
(60) Provisional application No. 62/367,608, filed on Jul. 27, 2016.

(51) Int. Cl. H02J 7/00

(52) U.S. Cl. CPC H02J 7/0091; H02J 7/0029

(57) ABSTRACT

A method for supplying power to a battery determines a first thermal budget for a first charging regulator. The method also determines a second thermal budget for a second charging regulator. The first charging regulator and the second charging regulator are coupled to the battery. The method further includes dynamically increasing a first charging regulator power output and substantially simultaneously decreasing a second charging regulator power output based on the first thermal budget and the second thermal budget.

### CROSS-REFERENCE TO RELATED APPLICATION

The present application claims the benefit of U.S. Provisional Patent Application No. 62/289,891, filed on Feb. 1, 2016, and titled “DYNAMIC THERMAL BALANCING OF PARALLEL REGULATORS TO REDUCE HOTSPOTS AND INCREASE PERFORMANCE,” and U.S. Provisional Patent Application No. 62/367,608, filed on Jul. 27, 2016, and titled “DYNAMIC THERMAL BALANCING OF PARALLEL REGULATORS TO REDUCE HOTSPOTS AND INCREASE PERFORMANCE,” the disclosures of which are expressly incorporated by reference herein in their entireties.

### TECHNICAL FIELD

The present disclosure generally relates to integrated circuits (ICs). More specifically, the present disclosure relates to dynamic thermal balancing of parallel regulators for reducing hotspots and increasing performance.

### BACKGROUND

As mobile computing devices (e.g., smart phones, computer tablets, and the like) continue to be used more widely, the need for fast charging of batteries becomes more significant. Advancements in fast battery charging techniques are being hampered by the high temperatures that result during fast charge sequences. In some cases, the high temperatures are caused by high inductor temperatures, which can exceed the temperature of the charging circuit.

Consumer and handheld equipment are specified to meet safety guidelines that limit the skin (or surface) temperature and prevent discomfort and health risks to the end user. As equipment, such as mobile handsets, continues to decrease in size, increase in functionality and increase in power capability, the need to maintain a safe skin temperature becomes more acute.

### SUMMARY

According to an aspect of the present disclosure, a method for supplying power to a battery determines a first thermal budget for a first charging regulator. The method also determines a second thermal budget for a second charging regulator. The first charging regulator and the second charging regulator are coupled to the battery. The method further includes dynamically increasing a first charging regulator power output and substantially simultaneously decreasing a second charging regulator power output based on the first thermal budget and the second thermal budget.

In another aspect, a power supplying apparatus comprises a first charging regulator and at least one first heat sensor proximate the first charging regulator. The apparatus also includes a second charging regulator. The first charging regulator and the second charging regulator are coupled to a battery to supply power to the battery. The apparatus also has at least one second heat sensor and a controller. The second heat sensor(s) is proximate the second charging regulator. The controller is configured to dynamically increase a first charging regulator power output and substantially simultaneously decrease a second charging regulator power output based on information from the first heat sensor(s) and the second heat sensor(s).

In yet another aspect, a power supplying apparatus comprises a first charging regulator and a second charging regulator. The first charging regulator and the second charging regulator are coupled to a battery to supply power to the battery. The apparatus includes a first heat sensor proximate the first charging regulator, and a second heat sensor proximate the second charging regulator. The apparatus also has means for dynamically increasing a first charging regulator power output and substantially simultaneously decreasing a second charging regulator power output based at least in part on information from the first heat sensor and the second heat sensor.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 shows a printed circuit board (PCB) level aspect of the present disclosure.

FIGS. 1A and 1B show additional illustrative aspects in accordance with the present disclosure.

FIG. 2 shows a general view of a charging circuit in accordance with the present disclosure.

FIG. 3 shows a single-phase configuration of a charging circuit in accordance with the present disclosure.

FIGS. 4A and 4B show a multi-chip-multi-phase configuration of charging circuits in accordance with the present disclosure.

FIGS. 5A, 5B, and 5C show another multi-chip-multi-phase configuration of charging circuits in accordance with the present disclosure.

FIG. 6 illustrates an example of an implementation of a master-only charging circuit in accordance with the present disclosure.

FIG. 7 illustrates an example of an implementation of a slave-only charging circuit in accordance with the present disclosure.

FIGS. 8A, 8B, and 8C illustrate an aspect for a dual-input master-slave configuration in accordance with the present disclosure.

FIG. 9 illustrates an aspect for a dual-input master in accordance with the present disclosure.

FIG. 10 shows thermal balancing in accordance with the present disclosure.

FIG. 11 shows an exemplary control loop in accordance with the present disclosure.

FIG. 12 shows a thermal balancing process in accordance with the present disclosure.

FIG. 13 is a block diagram showing an exemplary wireless communication system in which a configuration of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Dynamic thermal balancing can be applied among charging ICs or charging regulators during parallel charging. Parallel charging (also referred to as master+slave(s) charging) spreads the thermal load among multiple ICs operating simultaneously. Thus, hot spots on external surfaces of the mobile device (or skin temperature) are reduced and a more uniform distribution of heat is obtained. To reduce the hotspots, aspects of the present disclosure are directed to adjusting an output power of each of multiple charging regulators (e.g., voltage regulators) supplying power to a single load (e.g., battery) based on predefined thermal budgets specified for each of the multiple charging regulators and detected amount of heat dissipated at each of the charging regulators. Although a single load is described, the present disclosure also contemplates multiple loads or multiple battery cells.

In one aspect of the disclosure, a first thermal budget and a second thermal budget are respectively determined for a first charging regulator and a second charging regulator. The first and the second thermal budgets may be based on a current limit that may be predetermined or dynamically determined. The charging regulator can be a voltage and/or current based charging regulator. One or more heat sensors can detect the amount of heat dissipated at each of the first charging regulator and the second charging regulator. The one or more heat sensors may be based on implementations, such as analog, digital, voltage, or a type of thermocouple implementation that provides a representation of temperature. A controller (e.g., power management integrated circuit (PMIC)) then adjusts the first charging regulator power output and/or the second charging regulator power output based on the first thermal budget and a second thermal budget and the amount of heat dissipated at each of the first charging regulator and the second charging regulator. Adjusting the first charging regulator power output and/or the second charging regulator power output includes increasing or decreasing the first charging regulator power output and/or the second charging regulator power output.

To adjust the first charging regulator power output and/or the second charging regulator power output, the controller compares the amount of heat detected at the first and the second charging circuits and is then compares to their respective thermal budgets. The first charging regulator power output and/or the second charging regulator power output are then adjusted based on whether the amount of heat detected at the first and the second charging circuits are above or below their respective thermal budgets. For example, the controller dynamically increases a charging current, voltage and/or power input at the first charging regulator in response to a decrease in the amount of heat detected at the first charging regulator or in response “no change” in heat dissipated at the first charging regulator. The controller also substantially simultaneously decreases an amount of charging current, voltage and/or power output generated at the second charging regulator in response to an increase in the amount of heat detected at the second charging regulator.

For example, the amount of heat detected at the first charging regulator (e.g., 60 units) may be compared to the first thermal budget (e.g., a first thermal limit (e.g., 50 units) for the first charging regulator) and the amount of heat at the second charging regulator (e.g., 40 units) may be compared to the second thermal budget (e.g., a second thermal limit (e.g., 50 units)). When the amount of heat at the second charging regulator has decreased (e.g., by 50−40=10 units), and the amount of heat at the first charging regulator has increased (e.g., by 60−50=10) or remained the same, the first charging regulator power output and/or the second charging regulator power output is adjusted (increased or decreased) to optimize, improve or control the thermal environment of a device or system including the first and the second charging regulators. In this case, the first charging regulator power output is decreased while the second charging regulator power output is increased. The first thermal budget may be different from the second thermal budget.

Although two regulators are described to charge a single battery, multiple regulators (more than two) can be used to charge the single battery. Further, multiple regulators (two or more) can be used to charge multiple batteries. In some aspects, when each of the multiple regulators and/or multiple charging ICs have exceeded their thermal budget, an output power of the power supply (e.g., input power to the regulators or charging ICs) to the multiple regulators and/or multiple charging ICs is reduced.

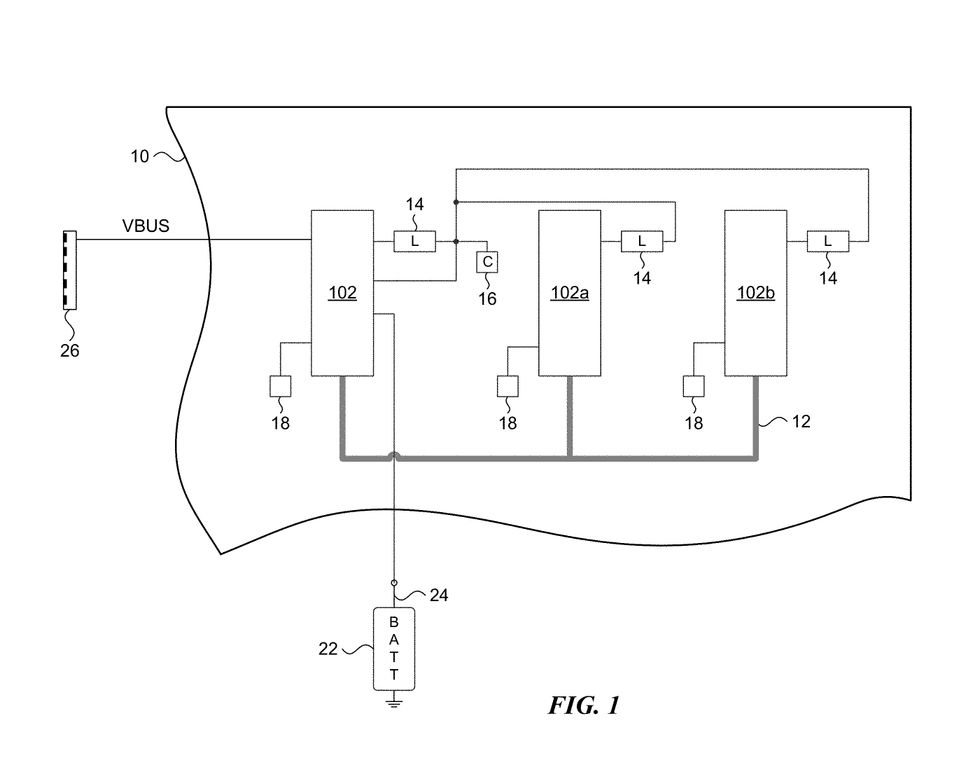

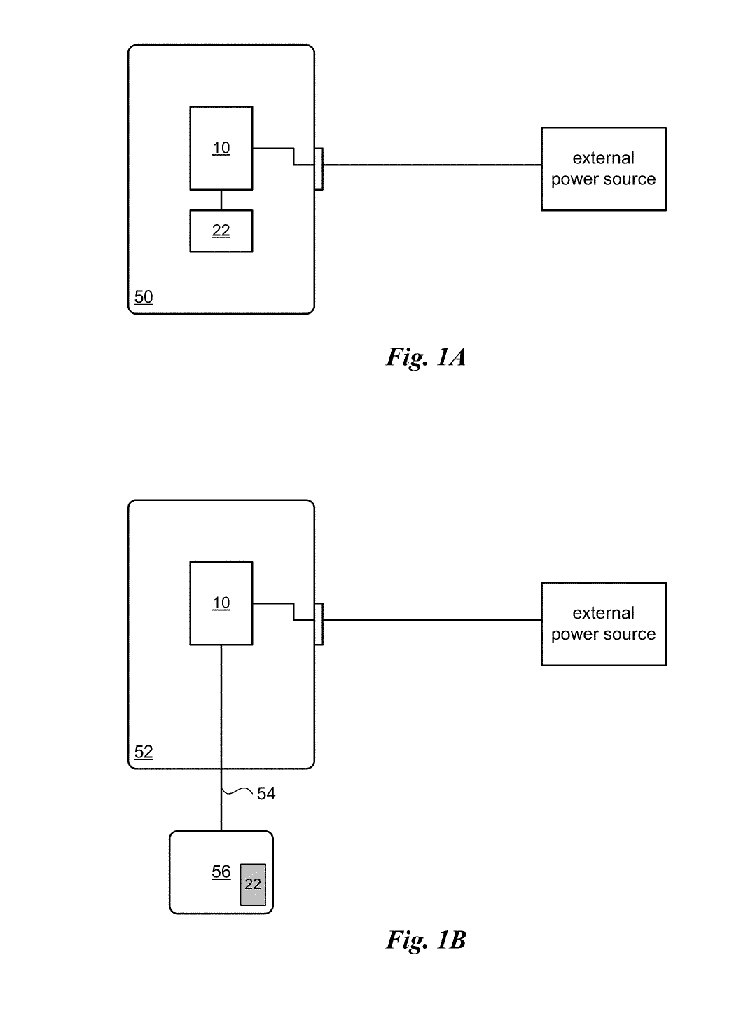

FIG. 1 shows a portion of a printed circuit board (PCB) 10 populated with battery charging devices in accordance with the present disclosure. The PCB 10 may be a circuit board, for example, in a mobile computing device, a smart phone, and in general any electronic device. The PCB 10 may be populated with battery charging devices 102, 102a, 102b. It will be appreciated in the discussions to follow that fewer or more battery charging devices may be provided. Each of the battery charging devices 102, 102a, 102b may be embodied in any suitable integrated circuit (IC) packaging format (e.g., single in-line packaging, dual in-line packaging, surface mount devices, and so on) and interconnected on the PCB 10.

In some aspects, the battery charging devices 102, 102a, 102b are identical devices that can be configured for different modes of operation. For example, a device 102 may be configured for “master” mode operation, while devices 102a, 102b may be configured for “slave” mode operation. It will be understood that battery charging devices 102, 102a, 102b may include pins or terminals (not shown) that allow the devices to be interconnected on the PCB 10 using PCB traces, represented generally by 12.

In accordance with principles of the present disclosure, the battery charging devices 102, 102a, 102b may be connected to a battery 22 via a connection 24 (e.g., battery terminal) for coordinated charging of the battery by the battery charging devices. The battery 22 may comprise any known configuration of one or more cells (e.g., a single-cell configuration, a multi-cell, multi-stack configuration, etc.) and may be use any suitable chemistry that allows for recharging.

In some aspects, the battery charging devices 102, 102a, 102b operate as buck converters, and in other aspects the battery charging devices may comprise buck-boost converters or capacitor dividers (charge pumps). In some aspects, the inductive component of the buck converter may be provided as external inductive elements 14 provided on the PCB 10. Accordingly, each battery charging device 102, 102a, 102b may be connected to a corresponding external inductive element 14, such as an inductor. The inductive elements 14 are “external” in the sense that they are not part of the charging ICs that comprise the battery charging devices 102, 102a, 102b. In accordance with the present disclosure, the capacitive component of the buck converters may be provided as an external capacitive element 16 on the PCB 10 that can be shared by each battery charging device 102, 102a, 102b. The capacitive element 16 is “external” in the sense that it is not part of the charging ICs that comprise the battery charging devices 102, 102a, 102b.

Further in accordance with the present disclosure, each battery charging device 102, 102a, 102b may be connected to a corresponding external selection indicator 18 to configure the device for master or slave mode operation. Each selection indicator 18 is “external” in the sense that it is not part of the charging IC that comprises the device. In some aspects, the selection indicator 18 may be a resistive element. For example, a connection to ground potential (e.g., approximately 0Ω) may serve to indicate the device (e.g., 102) should operate in master mode. A non-zero resistance value (e.g., 10KΩ, 100KΩ, etc.) may serve to indicate that the device (e.g., 102a, 102b) should operate in slave mode. More generally, in other aspects, the selection indicator 18 may be a source of a suitable analog signal or digital signal that can serve to indicate to the device 102, 102a, 102b whether to operate in master mode or slave mode.

Power to the battery charging devices 102, 102a, 102b may be externally provided via any suitable connector 26. Merely as an example, the connector 26 may be a USB connector. Power from the VBUS line of a USB connector may be connected to device 102 (e.g., at a USBIN terminal), which may then distribute the power to the other devices 102a, 102b via a MIDUSBIN terminal or in parallel to their individual USBIN terminals (if so equipped). These and other terminals will be described in more detail below.

One of ordinary skill will appreciate that aspects according to the present disclosure may include any electronic device. For example, FIG. 1A points out that the PCB 10 may be incorporated in any electronic device 50 to charge battery 22. FIG. 1B illustrates another configuration in which PCB 10 may be provided in a first electronic device 52 that has a connection 54 to a second electronic device 56 to charge the battery 22 in the second electronic device. In some aspects, the connection 54 may not be physical, for example, wireless energy transfer from device 52 may be provided using magnetic induction circuitry (not shown).

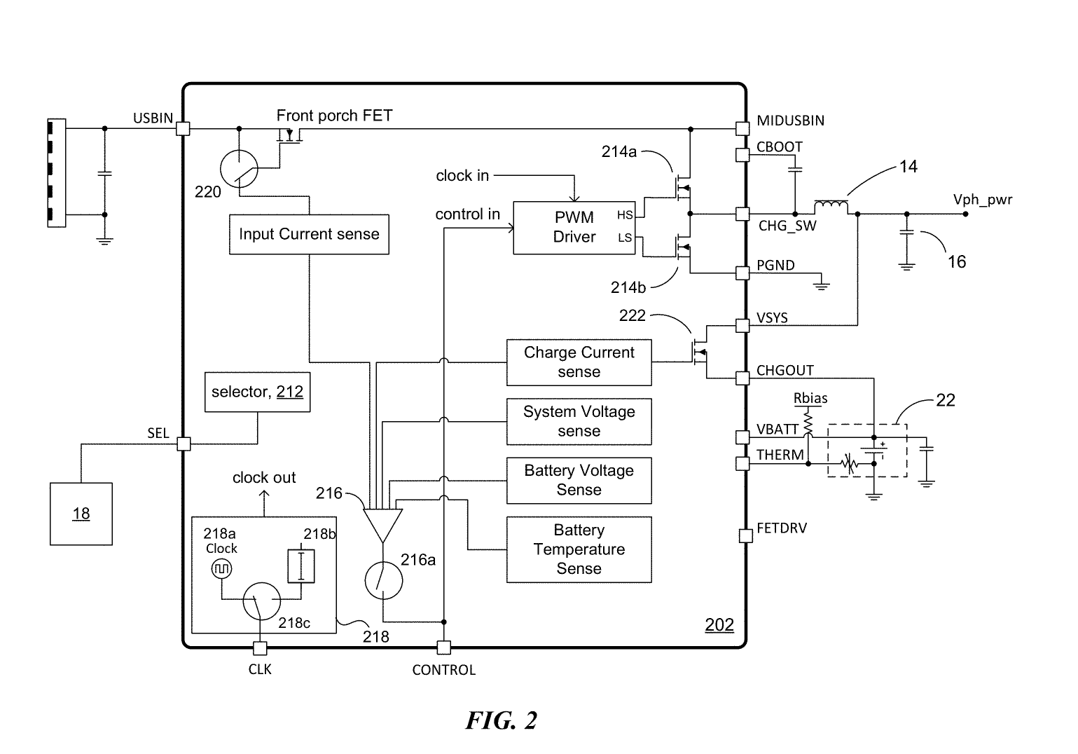

The battery charging device 102 is discussed in accordance with some aspects of the present disclosure. FIG. 2 shows a simplified schematic representation of the battery charging device 102. In some aspects, the battery charging device 102 may comprise a charging IC 202. It will be appreciated that in some implementations, the design of the charging IC may be implemented on two or more ICs. For purposes of discussion, however, we can assume a single charging IC implementation without loss of generality.

The charging IC 202 may comprise circuitry to provide battery charging functionality in accordance with principles of the present disclosure. In some aspects, for example, the battery charging functionality may be provided using a buck converter, or a buck-boost converter, or a charge pump, and so on. Accordingly, the charging IC 202 may include a high-side FET 214a and a low-side FET 214b that can be configured in a buck converter topology in conjunction with inductive element 14 and capacitive element 16.

A pulse width modulated (PWM) driver circuit may produce gate drive signals (HS, LS) at its switching output to switch the gates of respective FETs 214a and 214b. The PWM driver circuit may receive a current-mode control signal at its control input and a clock signal at its clock input to control the switching of FETs 214a and 214b. Power (Vph_pwr) from the buck converter may be connected to charge the battery 22 through battery FET 222 via the VSYS and CHGOUT terminals of the charging IC 202. The battery FET 222 may serve to monitor the charge current (e.g., using a charge current sense circuit).

In accordance with principles of the present disclosure, the control signal may be internally generated within the charging IC 202 or externally provided to the charging IC. For example, a feedback compensation network comprising various feedback control loops and a comparator 216 may serve as a source of an internally generated control signal. In a particular configuration, the feedback control loops may include an input current sense circuit (e.g., senses input current at USBIN), a charge current sense circuit (e.g., senses current at VSYS and CHGOUT terminals using battery FET 222), a system voltage sense circuit (e.g., senses voltage at VSYS terminal), a battery voltage sense circuit (e.g., senses battery voltage at VBATT terminal), and a battery temperature sense circuit (e.g., senses battery temperature at THERM terminal). In other aspects, the feedback control loops may comprise fewer, or additional, sense circuits. The comparator 216 may produce a reference that serves as the internally generated control signal.

The control signal produced by comparator 216 is “internal” in the sense that the control signal is generated by circuitry that comprises the charging IC 202. By comparison, a control signal is considered to be “externally” provided when the signal is received from a source external to the charging IC 202; e.g., via the CONTROL terminal of the charging IC. In some aspects, a control selector 216a may be provided to select either the internal control signal generated by the comparator 216 or an externally generated control signal received on the CONTROL terminal to serve as the control signal for the PWM driver circuit.

In accordance with principles of the present disclosure, the clock signal may be internally generated within the charging IC 202 or externally provided to the charging IC. For example, the charging IC 202 may include a clock generator 218 to produce a clock signal (clock out). The clock generator 218 may include a clock generating circuit 218a and a delay element 218b. The clock generating circuit 218a may produce a clock signal that serves as an internally generated clock signal. The delay element 218b may receive an externally provided clock signal.

The clock signal produced by the clock generating circuit 218a is “internal” in the sense that the clock signal is generated by circuitry that comprise the charging IC 202, namely the clock generating circuit. By comparison, a clock signal is considered to be “externally” provided when the signal is received from a source external to the charging IC 202; e.g., via the CLK terminal of the charging IC. In some aspects, a clock selector 218c may be provided to select either the internal clock signal generated by the clock generating circuit 218a or an external clock signal provided on the CLK terminal and delayed (phase shifted) by the delay element 218b to serve as the clock signal for the PWM driver circuit.

The charging IC 202 may include a selector circuit 212 to configure the charging IC to operate in “master” mode or “slave” mode according to the external selection indicator 18 provided on an SEL input of the charging IC. The selection indicator 18 may be a circuit, or a source of an analog signal (e.g., an analog signal generator) or a digital signal (e.g., digital logic). In some aspects, for example, the selection indicator 18 may be an electrical connection to ground potential, either directly or through a resistive element. The selector circuit 212 may operate the control selector 216a and the clock selector 218c according to the selection indicator 18. The selector circuit 212 may also operate a switch 220 to enable or disable sensing of the current input in accordance with the selection indicator 18.

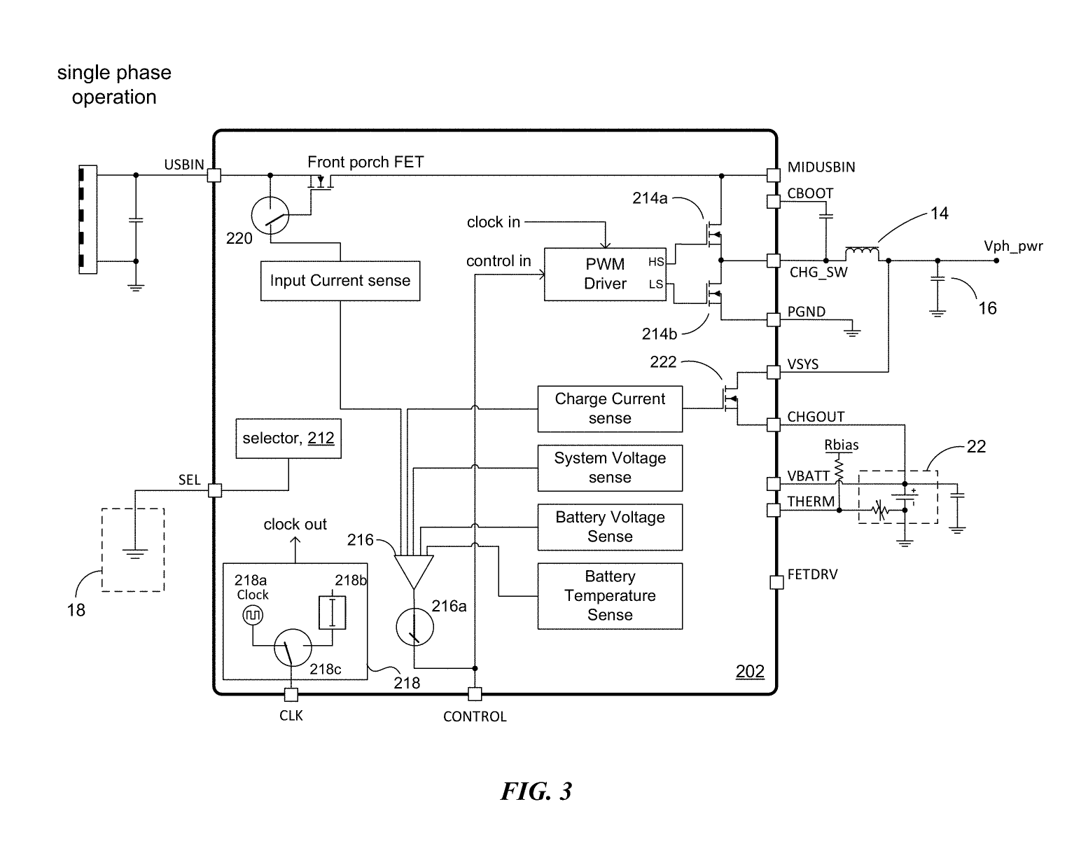

In accordance with the present disclosure, the charging IC 202 may be configured as a single-phase standalone device, or used in a multi-phase configuration. The discussion will first describe a single-phase configuration. FIG. 3 illustrates an example of the charging IC 202 configured to operate as a standalone battery charger. The charging IC 202 may be configured using the SEL input to operate in master mode. In some aspects, master mode operation in the charging IC 202 may be designated by a selection indicator 18 that comprises a connection of the SEL input to ground potential. This convention for designating master mode operation is used for the remainder of the disclosure with the understanding that, in other aspects, other conventions may be adopted to indicate master mode operation.

In an aspect, the selector 212 may be configured to respond to the presence of a ground connection at the SEL input by configuring the charging IC 202 for master mode operation. For example, the selector 212 may operate the control selector 216a in a first configuration to provide an internally generated control signal to the control input of the PWM driver circuit. The internally generated control signal is also provided to the CONTROL terminal of the charging IC 202, which for the single-phase configuration shown in FIG. 3 is not relevant.

Similarly, the selector 212 may operate the clock selector 218c in a first configuration to provide an internally generated clock signal (e.g., via clock generating circuit 218a) to the clock input of the PWM driver circuit. The internally generated clock signal is also provided to the CLK terminal of charging IC 202, which for the single-phase configuration shown in FIG. 3 is not relevant. The selector 212 may also operate switch 220 to a configuration that enables input current sensing on the power input USBIN.

In operation, the master-mode configured charging IC 202 shown in FIG. 3 operates as a buck converter to charge the battery 22. Feedback control to the PWM driver circuit is provided by the circuitry comprising the charging IC 202, and likewise, the clock signal to the circuit is provided from within the charging IC. The configuration is a “standalone” configuration in the sense that there is only one charging IC.

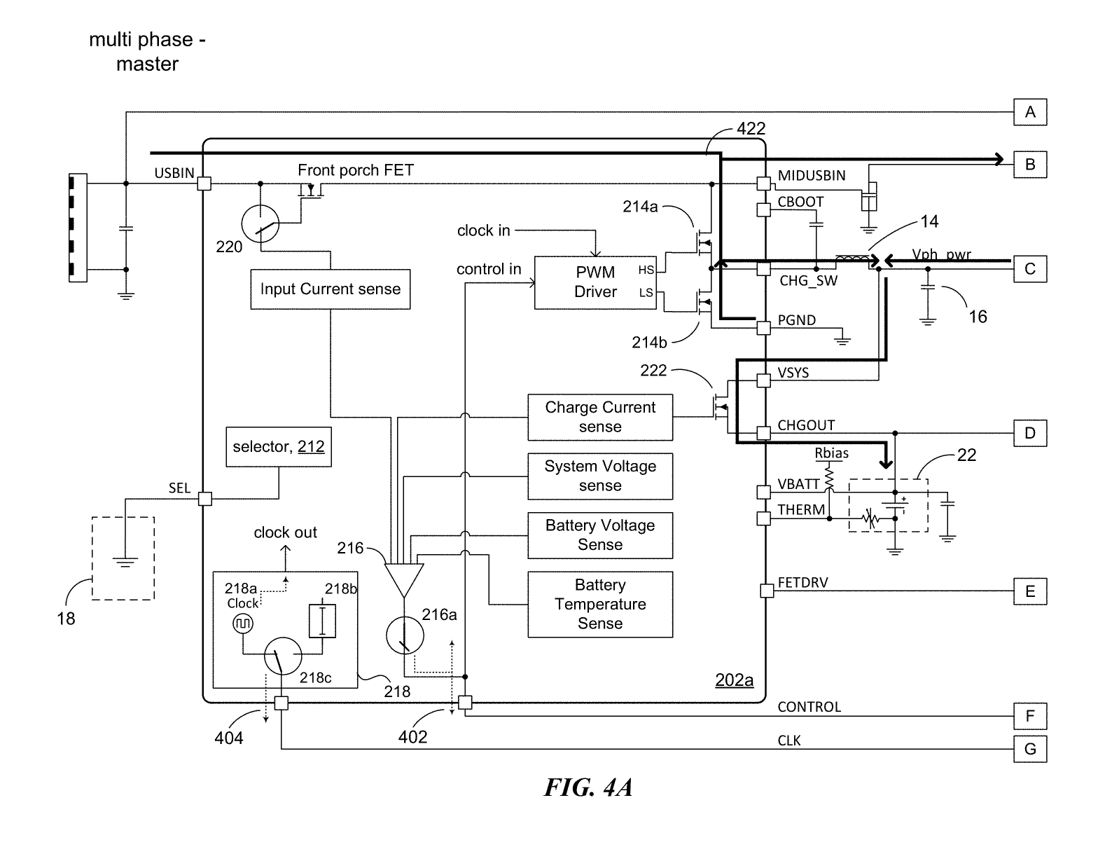

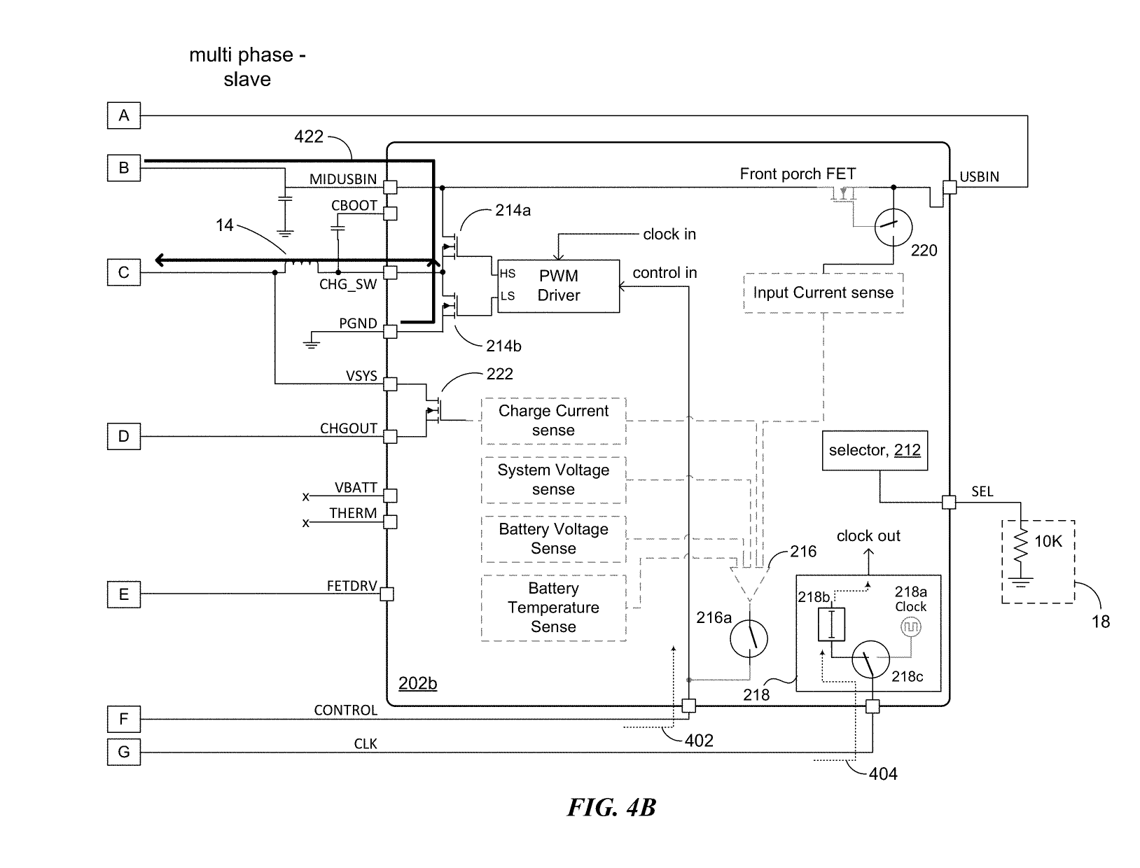

The discussion will now turn to a description of an example of a multi-phase configuration of the charging IC 202 in accordance with the present disclosure, and in particular a dual-phase configuration. In a dual-phase configuration, two charging ICs 202 are connected and operate together to charge a battery 22. One of the charging ICs 202 may be configured as a master device and the other as a slave device. FIGS. 4A and 4B show an example of charging ICs 202a and 202b configured to operate respectively as a master device and as a slave device. FIGS. 4A and 4B show a multi-chip-multi-phase configuration of charging circuits in accordance with the present disclosure. In one implementation, the multi-chip-multi-phase configuration may be a dual-phase configuration of charging circuits. The charging ICs 202a, 202b are connected together at connections A, B, C, D, E, F, and G. The resulting current flow is illustrated in FIGS. 4A and 4B as flow 422.

The charging IC 202a shown in FIG. 4A is configured for master mode operation as described in FIG. 3. In accordance with the present disclosure, the control signal generated by the comparator 216 in the charging IC 202a is provided as an externally generated control signal 402 (e.g., via the CONTROL terminal), in addition to serving as an internally generated control signal for the PWM driver circuit in the charging IC. Similarly, the clock signal generated by the clock generator 218 is provided as an externally generated clock signal 404 (e.g., via the CLK terminal), in addition to serving as an internally generated clock signal for the PWM driver circuit in the charging IC 202a.

Referring to FIG. 4B, the charging IC 202b is configured for slave mode operation. The charging IC 202b may be configured using the SEL input to operate in slave mode. In some aspects, slave mode operation may be designated by a selection indicator 18 that comprises a resistive element. This convention for designating slave mode operation is used for the remainder of the disclosure with the understanding that, in other aspects, other conventions may be adopted to indicate salve mode operation. In a particular aspect, for example, a 10K resistor may indicate slave mode operation. It will be appreciated, of course, that another resistance value may be used. The selector 212 may be configured to respond to the detection of a 10KΩ resistance at the SEL input by configuring the charging IC 202b for slave mode operation.

In slave mode operation, the selector 212 may operate the control selector 216a in a second configuration to receive the externally generated control signal 402 that is received on the CONTROL terminal of the charging IC 202b. The control selector 216a provides the externally generated control signal 402 to the control input of the PWM driver circuit. Operation of the control selector 216a in the second configuration disconnects or otherwise effectively disables the feedback network in the charging IC 202b from the PWM driver circuit. This “disconnection” is emphasized in the figure by illustrating the elements of the feedback network in the charging IC 202b using broken grayed out lines.

The selector 212 in the charging IC 202b may also operate the clock selector 218c in a second configuration to receive the externally generated clock signal 404 on the CLK terminal. The clock selector 218c provides the externally generated clock signal 404 to the delay element 218b. The clock signal that is provided to the PWM driver circuit comes from the delay element 218b, thus disconnecting or otherwise effectively disabling the clock generating circuit 218a in the charging IC 202b.

The switch 220 may be configured (e.g., by the selector 212) to disable current sensing at the USBIN terminal of the charging IC 202b. Power to the high- and low-side FETs 214a, 214b may be provided by the MIDUSBIN terminal via connection B. Similarly, charge current sensing in the slave-configured charging IC 202b may be disabled by disabling its battery FET 222.

As can be appreciated from the foregoing description, operation of the PWM driver circuit in the slave-mode charging IC 202b is controlled by the control signal and clock signal generated in the master-mode charging IC 202a and provided to the slave-mode charging IC 202b, respectively, as externally generated control and clock signals 402, 404. From the point of view of the slave-mode charging IC 202b, the control and clock signals generated in the master-mode charging IC 202a are deemed to be “externally generated.”

The master-mode charging IC 202a may synchronize with the slave-mode charging IC 202b by asserting a signal on the FETDRV terminal. For example, when the master-mode charging IC 202a pulls the FETDRV terminal LO, the PWM driver circuit in the slave-mode charging IC 202b is disabled. When the master-mode charging IC 202a pulls the FETDRV terminal HI, the PWM driver circuit in the slave-mode charging IC 202b begins switching. In some aspects, the FETDRV terminal may be used by the master-mode charging IC 202a to initiate switching in the slave-mode charging IC 202b after the input current rises above a threshold level, in order to balance light-load and heavy-load efficiency. For example, switching losses at light load can outweigh the decreased conduction losses, which can be avoided by not enabling the slave-mode charging IC 202b right away. After enablement, the slave-mode charging IC 202b operates in synchrony with the clock signal from the master-mode charging IC 202a. Control of the PWM driver circuit in the slave-mode charging IC 202b is provided by the control signal from the master-mode charging IC 202a, thus allowing the master to set the charge current limit, input current limit, etc.

In accordance with the present disclosure, the delay element 218b may be configured (e.g., by selector 212) to provide a selectable phase shift that is suitable for dual-phase operation. For example, the delay element 218b may provide a 180° phase shift of the externally generated clock signal 404. Accordingly, the clock signal provided to the clock input of the PWM driver circuit in the slave-mode charging IC 202b is 180° out of phase relative to the clock signal in the master-mode charging IC 202a. Consequently, the charging cycle of the master-mode charging IC 202a is 180° out of phase relative to the charging cycle of the slave-mode charging IC 202b. For example, when the high-side FET 214a is ON in the master device, the high-side FET in the slave device is OFF, and vice-versa.

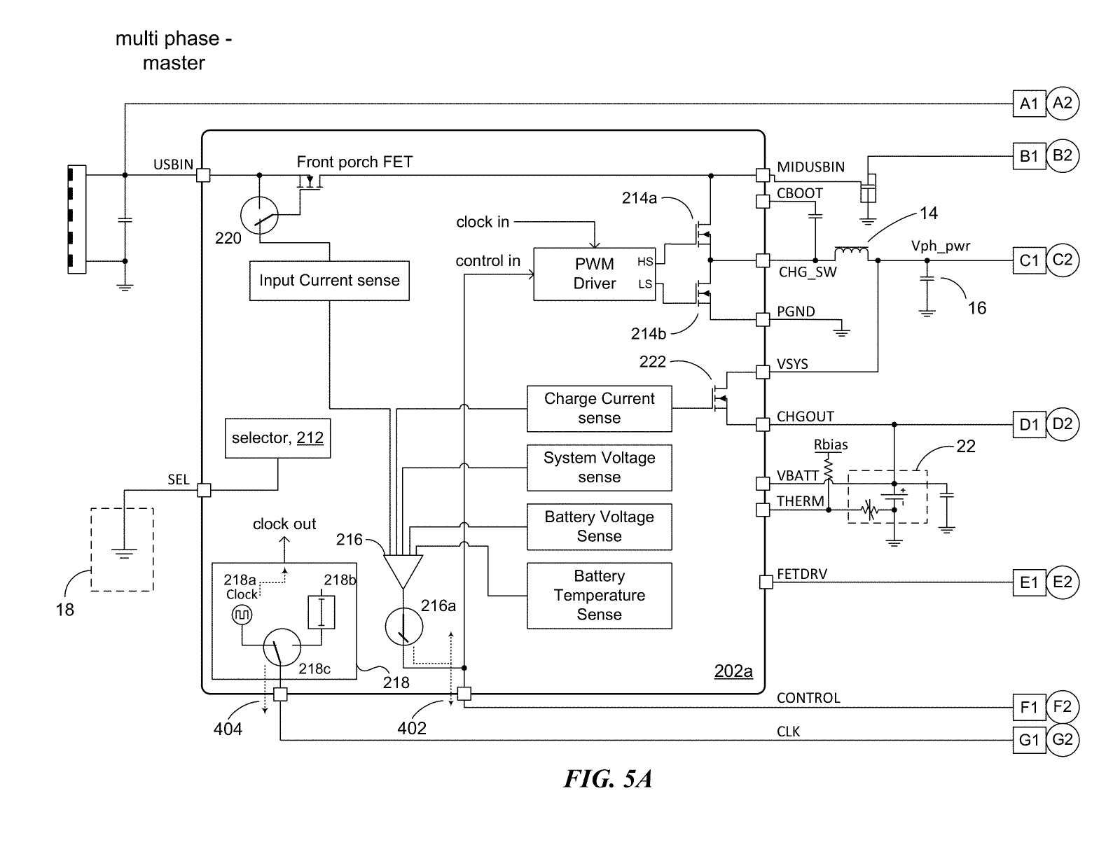

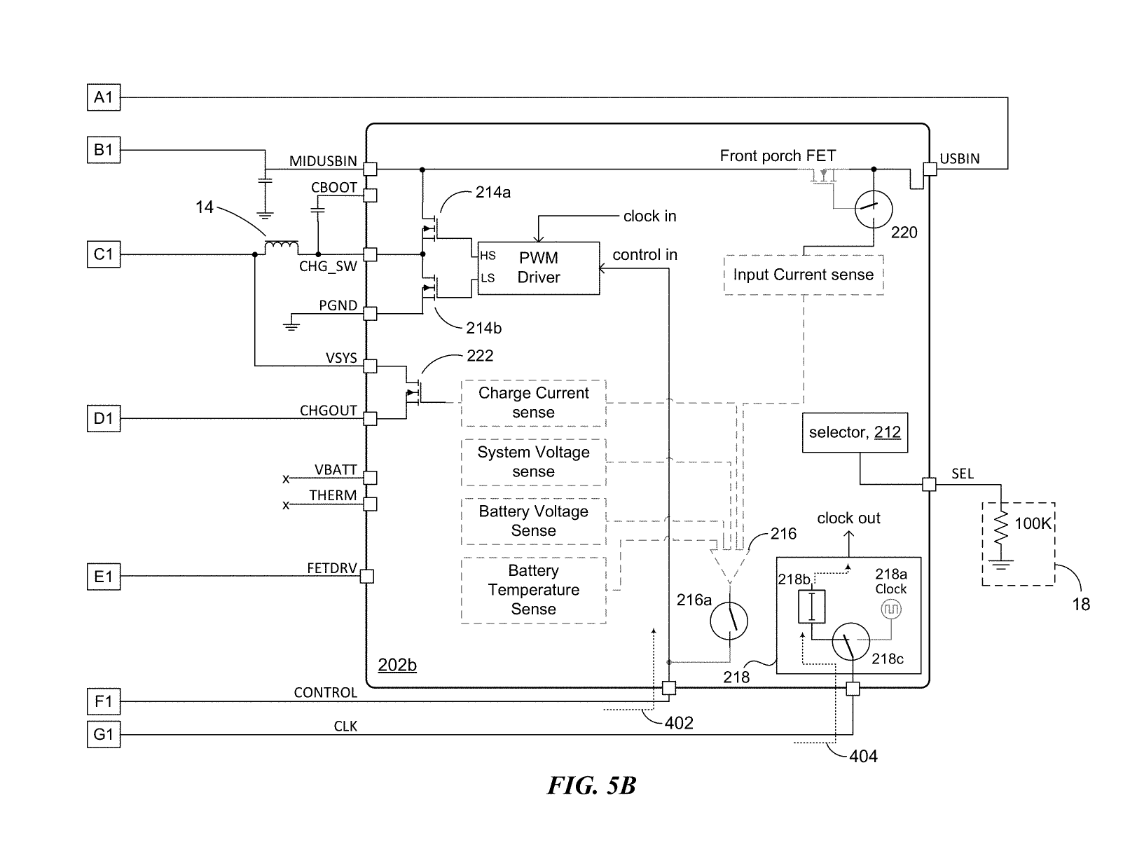

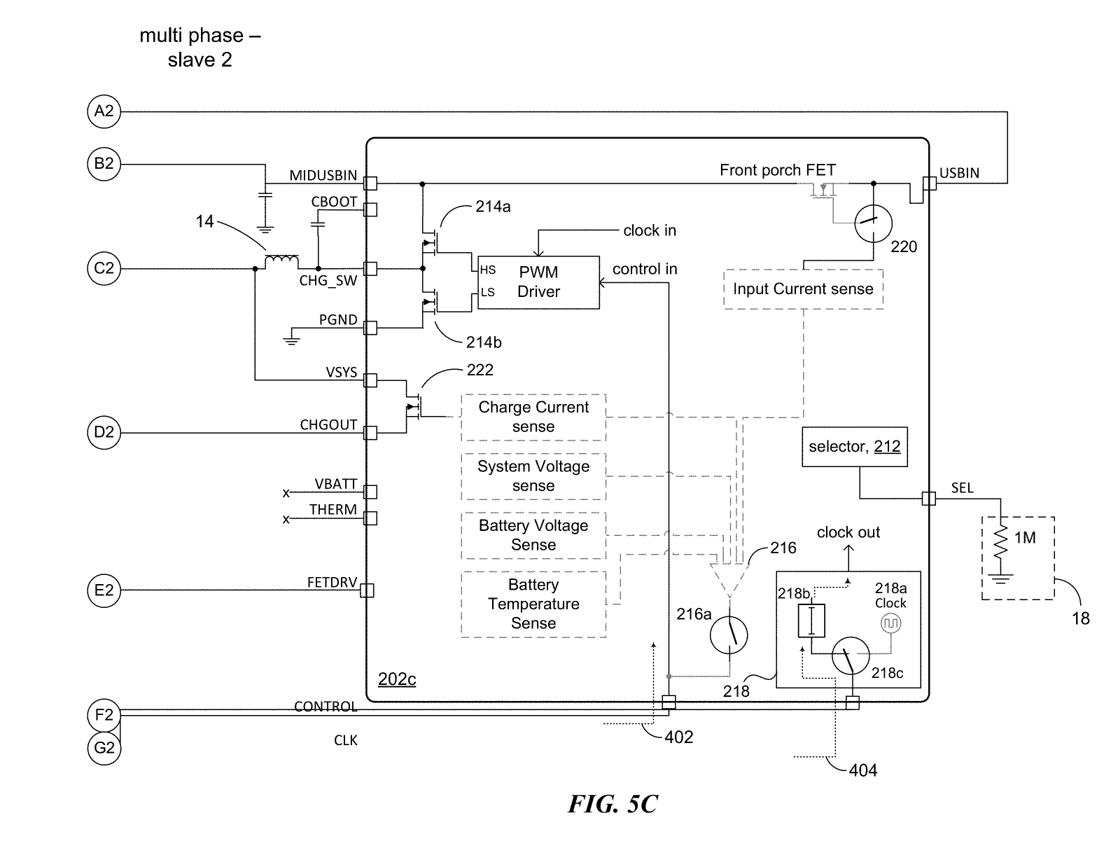

The discussion will now turn to a description of a 3-phase configuration of the charging IC 202 in accordance with the present disclosure. In a 3-phase configuration, three charging ICs 202 are connected and operate together to charge a battery 22. One of the charging ICs 202 may be configured as a master device and the other two as slave devices. FIGS. 5A-5C show an example of charging ICs 202a, 202b, and 202c configured to operate respectively as a master device, a first slave device, and a second slave device. FIGS. 5A-5C show other multi-chip-multi-phase configurations of charging circuits in accordance with the present disclosure. In one implementation, the multi-chip-multi-phase configuration may be a three-phase configuration of charging circuits. The charging ICs 202a, 202b, 202c are connected at connections A1, B1, C1, D1, E1, F1, and G1 and connections A2, B2, C2, D2, E2, F2, and G2.

The master device in FIG. 5A is configured as explained in connection with FIG. 4A. The first and second slave devices (FIGS. 5B and 5C) are configured as explained in connection with FIG. 4B. In 3-phase operation, the delay elements 218b in the first and second slave devices may be configured to provide 120° and 240° phase shifts, respectively, of the externally generated clock signal 404 as the clock input for the respective PWM driver circuits. For example, the selection indicator 18 in the first slave device of FIG. 5B may be a 100K resistor to indicate 120° phase shift, and similarly, the selection indicator 18 in the second slave device of FIG. 5C may be a 1M resistor to indicated 240° phase shift. It will be appreciated, of course, that other resistance values may be used. In operation, the charging cycle of the master device (FIG. 5A) is 120° out of phase relative to the charging cycle of the first slave device (FIG. 5B) and 240° out of phase relative to the charging cycle of the second slave device (FIG. 5C).

It will be appreciated that, more generally, N-phase operation may be provided using N charging ICs (one master device and (N−1) slave devices) and connecting them in accordance with the examples shown in the figures. Each of the (N−1) slave devices receives from the master device the externally generated control signal 402 and the externally generated clock signal 404. In some aspects, the m^{th} slave device may be configured (e.g., using a suitable selection indicator 18) to provide an m×(360÷N°) phase shift (e.g., using the delay element 218b) of the externally generated clock signal 404 as the clock input for its PWM driver circuit. In some aspects, the quantity (m÷N) is an integral multiple of 360.

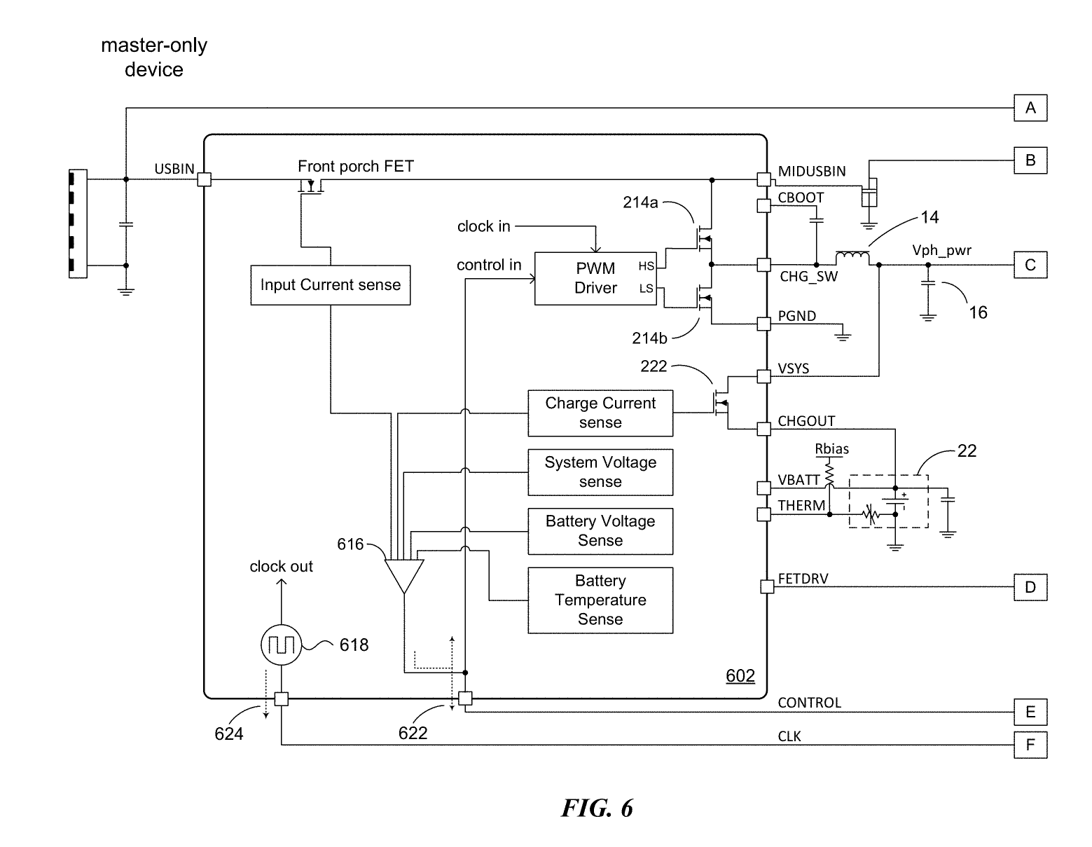

The discussion will now turn to another aspect of charging ICs in accordance with the present disclosure. In some aspects, a charging IC may be implemented as a master-only device. In other words, the charging IC always operates in master mode and is not configurable to operate as a slave device. FIG. 6, for example, shows a charging IC 602 comprising, among other components, a feedback network comprising several sensor components (e.g., input current sense, charge current sense, etc.) that feed into a comparator 616. The comparator output generates an internally generated control signal that feeds into the control input of the PWM driver circuit and which serves as an externally generated control signal 622 that is output at the CONTROL terminal. The charging IC 602 further comprises a clock 618 that generates a clock signal that generates an internally generated clock signal, which feeds into the clock in the PWM driver circuit, and which serves as an externally generated clock signal 624 that is output at the CLK terminal. This particular aspect of a charging IC uses its internally generated control and clock signals and outputs those signals as respective externally generated control and clock signals. As such, the charging IC 602 can omit the selector 212, selectors 216a, 218c, and 220, and the delay element 218b in order to realize a smaller, lower cost device.

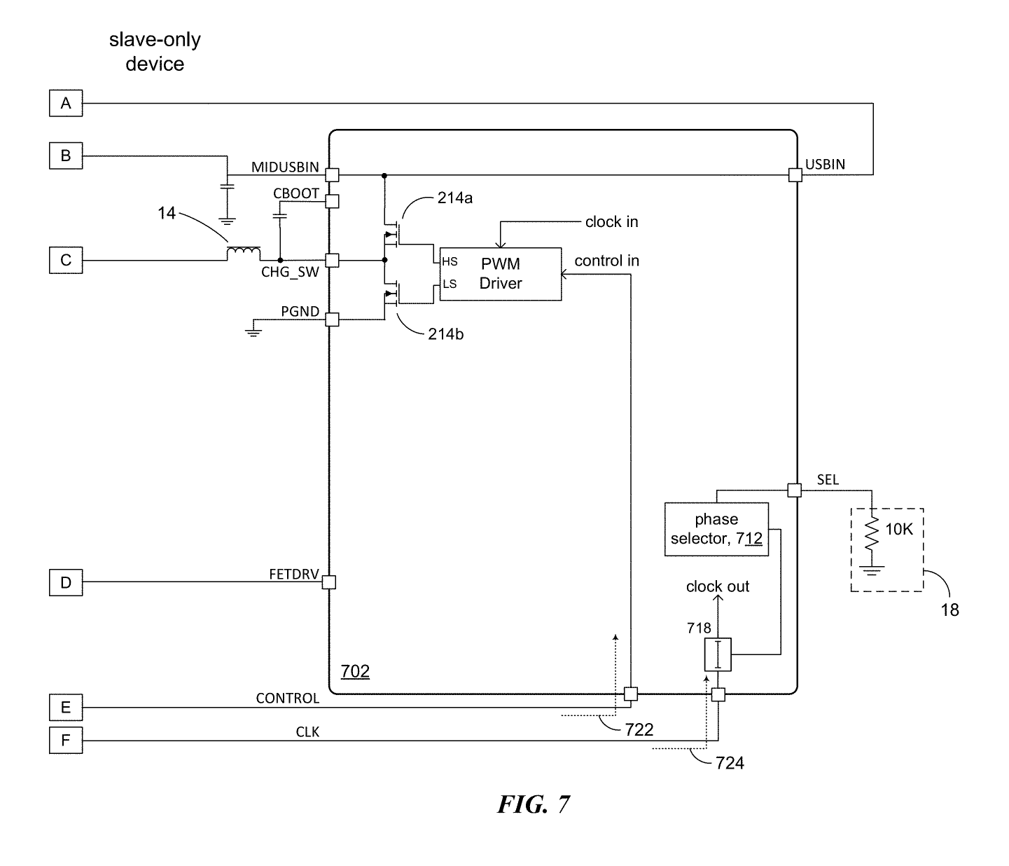

In some aspects, a charging IC may be implemented as a slave-only device. FIG. 7, for example, shows a charging IC 702 comprising a PWM drive circuit having a control input that receives only an externally generated control signal 722 (e.g., from the CONTROL terminal). The PWM driver circuit, furthermore, has a clock input that receives only an externally generated clock signal 724 (e.g., from the CLK terminal). The selector 712 serves to configure a delay element 718 to provide phase shifting of the externally generated clock signal 724 according to the selection indicator 18. For example, the delay element 718 may be configured to provide an m×(360÷(M+1)°) phase shift of the externally generated clock signal depending on what is connected to the selector 712, where m identifies the charging IC 702 as being the m^{th} slave device among a total of M slave devices.

The charging IC 702 is “slave-only” in the sense that it does not generate its control and clock signals internally, but rather obtains them from a source external to the charging IC. Because the control signal and clock signal are externally generated, the slave-only charging IC 702 can omit the circuitry comprising the feedback network and the clock. Likewise, the slave-only charging IC 702 can omit the input FET and battery FET, because the device does not sense the input current. This can be advantageous in terms of a smaller device and/or a lower cost device, especially because the input and battery FETs are power FETs that can occupy significant areas on the die.

In some aspects, the slave-only charging IC 702 may include additional circuitry to enhance performance. Though not illustrated, for example, a slave-only charging IC may include inductor current sense circuitry for peak current limiting. As another example, a slave-only charging IC may additionally include a thermal loop to ensure the junction temperature does not exceed a maximum operating limit.

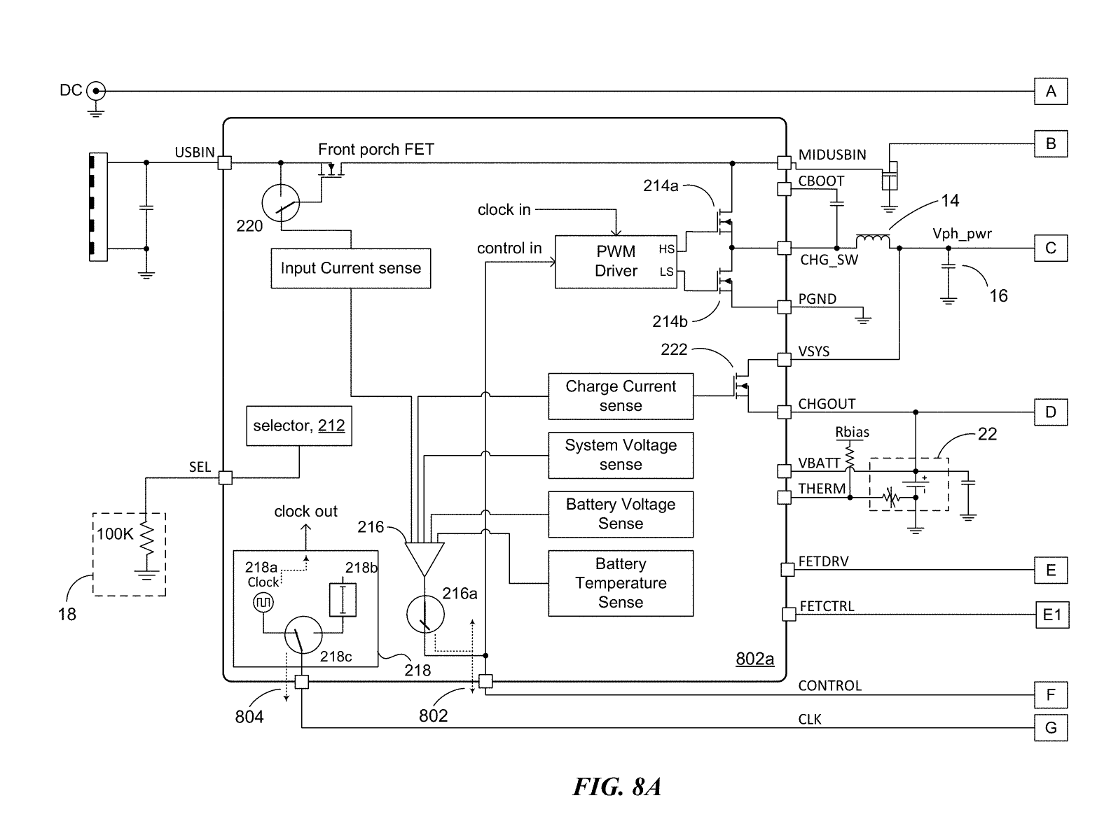

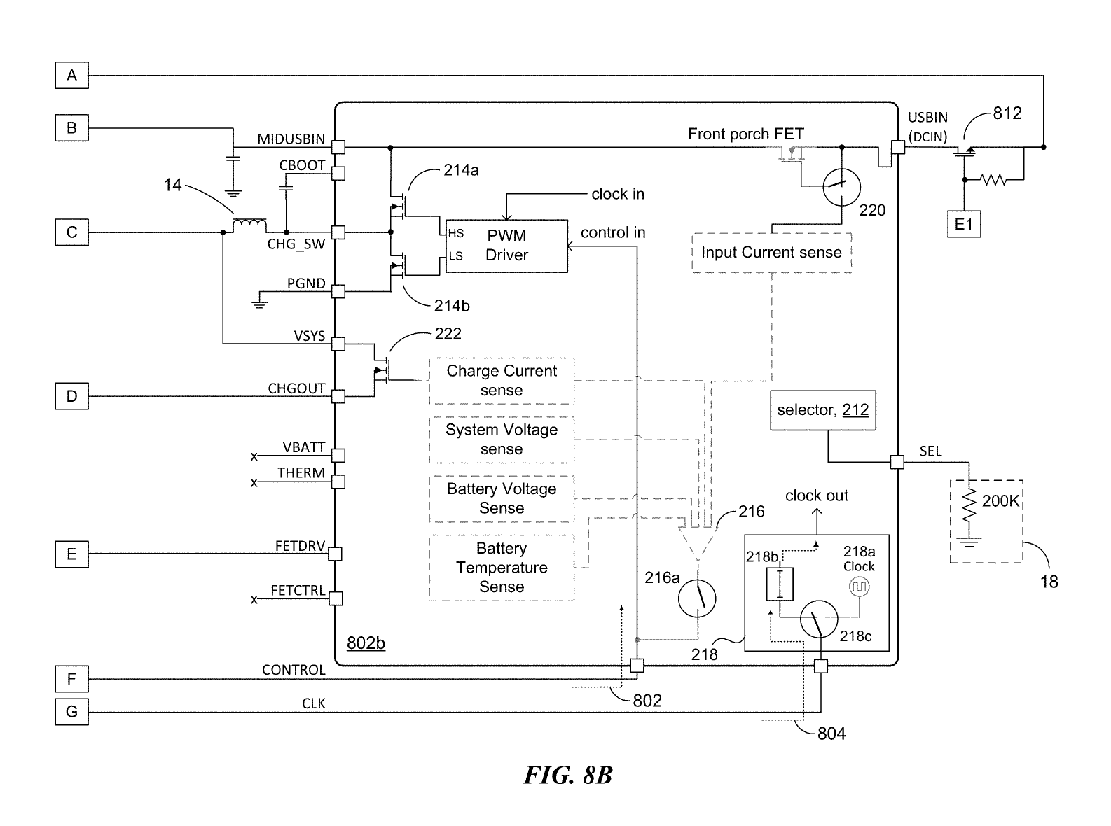

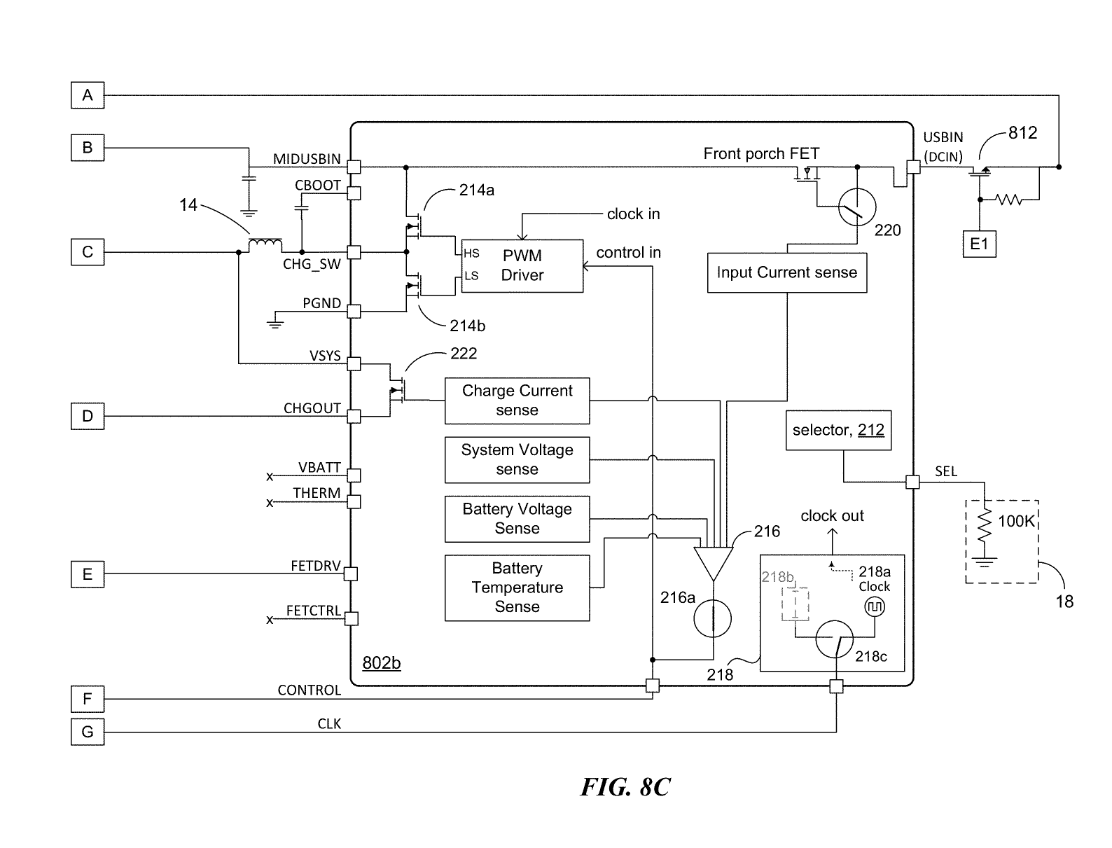

The discussion will now turn to a description of a dual-input two-phase master-slave configuration. Referring to FIGS. 8A, 8B, and 8C, a charging IC in accordance with the present disclosure may further include a FETCRTL terminal. FIG. 8A shows the charging IC 802a configured as a dual-input master. In a particular aspect, for example, the dual-input master configuration may be indicated with a selection indicator 18 that comprises a 100KΩ2 resistor. FIG. 8B shows the charging IC 802b configured as a dual-input slave, operating in slave mode. FIG. 8C shows the charging IC 802b operating in master mode. In a particular aspect, the dual-input slave configuration may be indicated using a selection indicator 18 that comprises a 200KΩ resistor. The configuration is “dual-input” in the sense that there are two voltage inputs. A first voltage input (e.g., USBIN) may be connected to the dual-input master 802a and a second voltage input (e.g., DCIN) may be connected to the dual-input slave 802b via a DCIN FET 812, as illustrated in FIGS. 8A-8C for example.

In operation, when there is a voltage on USBIN terminal of the dual-input master 802a, the dual-input configured charging ICs 802a and 802b operate in a master/slave mode as explained above. For example, the dual-input master 802a generates a feedback control signal 802 that is used by the master and provided to the slave (FIG. 8B) via the CONTROL terminal. Likewise, the dual-input master 802a generates a clock signal 804 that is used by the master and provided to the slave via the CLK terminal. The dual-input slave 802b shown in FIG. 8B uses the externally provided control signal 802 and clock signal 804 to control its PWM driver circuit. In addition, the dual-input master 802a asserts FETCTRL (e.g., goes high-z) to turn OFF the DCIN FET 812 that is connected to the dual-input slave 802b. This serves to electrically isolate the DCIN voltage source (if present) from the USBIN (DCIN) terminal of the dual-input slave 802b. The dual-input master 820a asserts FETDRV (e.g., pulls HIGH) to signal the dual-input slave 802b to operate in slave mode.

When there is no voltage on the USBIN terminal of the dual-input master 802a, the master does not perform battery charging. The dual-input master 802a asserts FETCTRL (e.g., goes LOW) to turn ON the DCIN FET 812 to allow current flow from the DCIN voltage source. The dual-input slave 802b operates in master mode to perform battery charging using the DCIN input provided on its USBIN terminal. This master operating mode of the dual-input slave 802b is illustrated in FIG. 8C. Notably, the dual-input slave 802b does not receive an external control signal or clock signal on its CONTROL and CLK terminals, because the dual-input master 802a is not performing battery charging. Instead, the dual-input slave 802b generates its own control and clock signals and performs battery charging from DCIN in master mode.

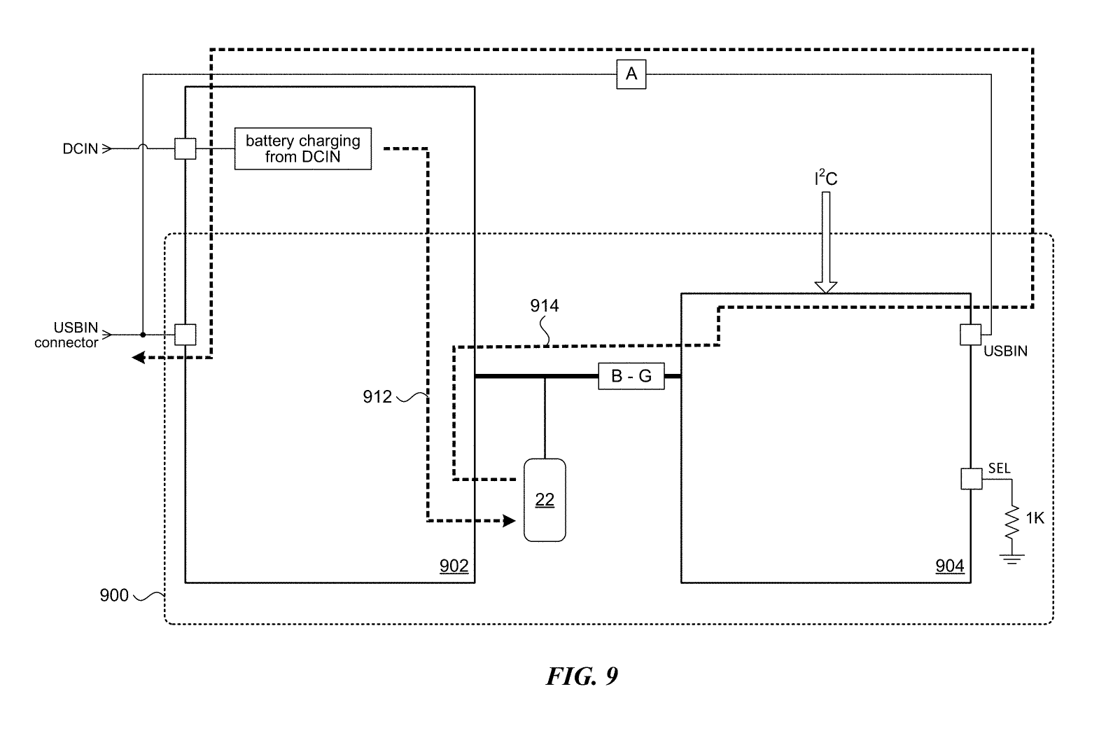

The discussion will now turn to a description of a multi-phase master-slave configuration using, as the master device, a charging IC of the present disclosure configured for two voltage source inputs. FIG. 9 illustrates a dual-input charging IC 902 configured with a charging IC 904 configured for slave mode operation. The bounding box 900 is used to indicate that device 904 and a portion of device 902 are configured as illustrated in FIGS. 4A and 4B. In some aspects, the device 902 may be configured to always operate in master mode. The device 904 may be configured with a selection indicator comprising a 1 kΩ resistor to indicate that the slave may operate in on-the-go (OTG) mode.

In operation, when charging from USBIN, the devices 902, 904 may operate in master/slave mode to provide multi-phase charging of the battery 22 as explained in the foregoing aspects. However, when the device 902 is charging from DCIN, the device 904 may be signaled to operate in OTG mode. For example, the device 904 may include interface circuitry (not shown) to receive a command via the Inter-Integrated Circuit (I²C) communication protocol. It will be appreciated, of course, that any other suitable signaling may be used.

In OTG mode, the device 904 provides power from the battery 22 directly to the USBIN terminal. FIG. 9 illustrates the two different current flows 912, 914 in this “OTG” mode of operation. Flow 912 represents charging current from the dual-input charging IC 902 to charge the battery 22. Flow 914 represents current from the battery 22 to the USBIN terminal of device 902. It is noted that though control and clock signals from the device 902 may be provided on its respective CONTROL and CLK terminals, the signals are not used by the device 904 in OTG mode.

Aspects of the present disclosure are directed to battery chargers (e.g., charging regulators) with power processing stages operating in parallel configuration. While the battery chargers may be implemented according to a “master” and “slave” control implementation, the battery chargers are not limited to the master/slave implementation. The aspects of the present disclosure are also applicable to any power processing stage operating in parallel configuration such as powering loads as a core, graphics power, liquid crystal display (LCD) backlight, signage, etc. The aspects of the disclosure can also be implemented in accordance with linear regulators (or low drop out regulators), as well as any switch-mode-converter topology (e.g., buck, buck-boost, boost, capacitive multiplier or divider).

Load sharing among the ICs can be fixed for a different use cases. According to aspects of the present disclosure, however, the load sharing is dynamically adjusted based on readings from embedded temperature sensors. The dynamic load balancing helps maintain an evenly distributed temperature profile on the surface or skin of the equipment. The sensors react to nearby heat sources as well as variations in the equipment's ambient temperature. The thermal sensors may be embedded in the charging ICs or placed elsewhere within the equipment. Thus, when nearby loads/heat sources change or the ambient temperature changes, the ICs can be controlled accordingly.

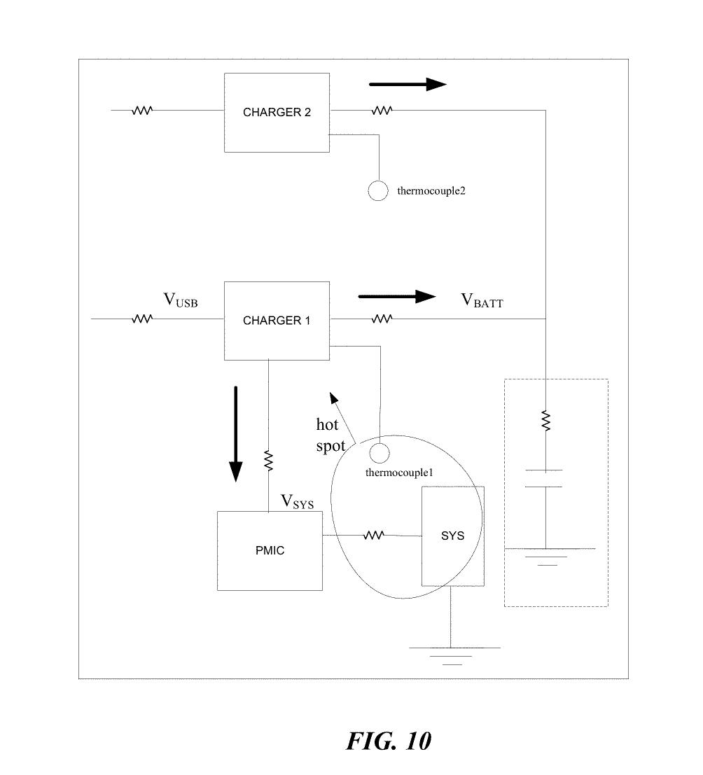

For example, as shown in FIG. 10, two charging ICs may be present in a single phase buck and OTG (boost) setup. In this example, the load (SYS) produces heat that spreads towards the first charging IC (CHARGER 1), which is closer to the heat source than the second IC (CHARGER 2.) The first heat sensor (thermocouple 1) detects the increase in heat. The second IC (CHARGER 2) is not affected by this heat as recognized by the second heat sensor (thermocouple 2). Therefore, the second charging IC (CHARGER 2) has a higher thermal margin than the first charging IC (CHARGER 1). According to aspects of the present disclosure, a controller, such as the power management IC (PMIC), adjusts the parallel charging allocation so that the second charging IC (CHARGER 2) carries more of the charging load, while the first charging IC reduces its output current.

If the initial load sharing ratio was 60% to CHARGER 1 and 40% to CHARGER 2, the load sharing could be altered to 40% to CHARGER 1 and 60% to CHARGER 2. That is, the temperature associated with the first charging IC is Skin#1, and the temperature associated with the second charging IC is Skin#2. In the first scenario, Skin#1+Skin#2 exceeded the safety limit, for example 40C, because of the heat emanating from the load (SYS). Because the skin temperature was exceeded, conventionally, overall charging would be reduced. That is, if either parallel charger overheats, both charging ICs would be throttled down.

According to the present disclosure, once the load sharing is employed, the skin temperature (Skin#1+Skin#2) would remain below 40 C, while the overall charging rate is maintained. That is, the first charging IC would reduce its charging power to 40%, but the second charging IC would increase is charging power to 60%, if possible. Thus, the charging current is directed towards the coolest charging IC.

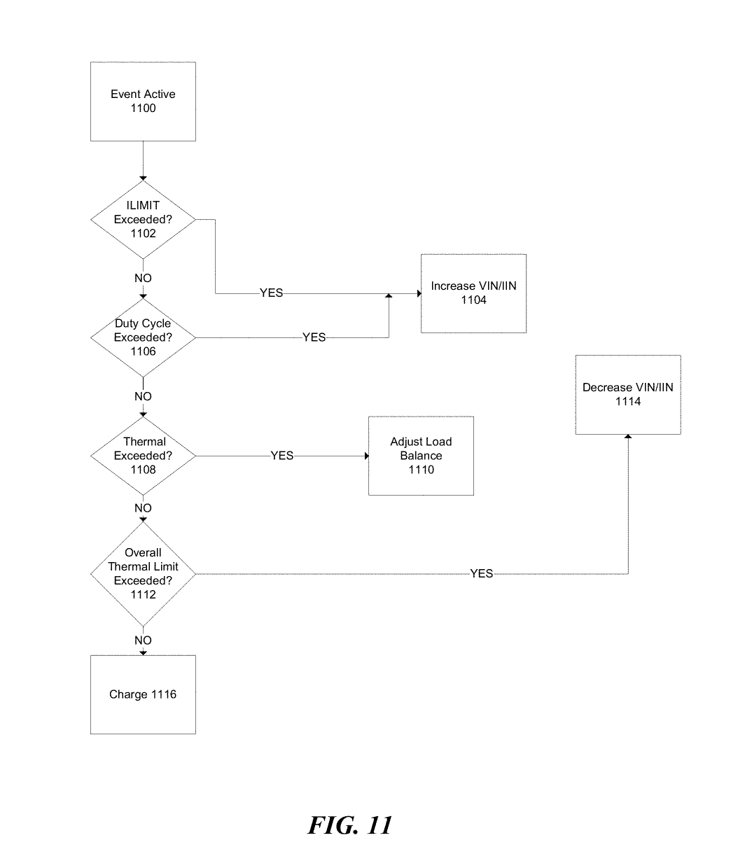

Thermal balancing could be implemented as an additional control loop within an adaptive charging process. FIG. 11 shows an exemplary control loop. At block 1100, a charging event is triggered. At block 1102, it is determined whether an input current limit (ILIMIT) is exceeded. If so, at block 1104, the power increases (e.g., input voltage VIN and/or input current IIN increases) and the process returns to block 1100. If not, it is determined whether a duty cycle has been exceeded at block 1106. For example, the duty cycle in a switching regulator (e.g., buck switching regulator) is: Duty Cycle=Vout/Vin. If the input voltage drops to a level close to the output voltage, the duty cycle may increase. However, if the input voltage is too low, the duty cycle may reach a maximum duty cycle, and the system may not be able to produce the desired charge current. Accordingly, aspects of the disclosure prevents the duty cycle from exceeding a maximum duty cycle. To prevent the duty cycle from exceeding a maximum duty cycle, when it is determined that a specified or pre-defined duty cycle is exceeded, the power increases (e.g., input voltage VIN and/or input current IIN increases) at block 1104, and the process returns to block 1100. This increase in power may only be allowed to happen when the thermal budget of both regulators is not exceeded.

If the duty cycle has not been exceeded, at block 1108, it is determined whether a thermal limit is exceeded. If the thermal limit is exceeded, at block 1110, the load balance between the charging ICs is adjusted. For example, if the first charging IC is experiencing more heat, then the load of the first charging IC is decreased while the current of the second charging IC is increased (by the second charging IC) by the amount the first charging IC decreased its charging current. If only a portion of the decrease can be accommodated by the second charging IC without exceeding the overall skin temperature, then the second charging IC increases its current as much as possible without exceeding the maximum skin temperature.

If the thermal limit is not exceeded (1108: NO) or after the load balance is adjusted, at block 1112, the overall thermal conditions are checked. That is, at block 1112 it is determined whether the die temperature as well as the skin temperature satisfy the desired thermal limits. If the limits are exceeded, at block 1114, the power is decreased (e.g., input voltage VIN and/or input current IIN is decreased) and the process returns to block 1100. If all thermal limits are met (1112: NO), constant current, constant voltage (CC/CV) charging proceeds at block 1116.

Although the preceding thermal balancing is described with respect to multiple charging ICs, the concepts also apply to multiple regulators, such as charge pumps, within a single charging IC. Such a concept applies to battery charging, as well as other use cases such as core regulators. For example, when each of the multiple regulators and/or multiple charging ICs have exceeded their thermal budget, an output power of the power supply (e.g., input power to the regulators or charging ICs) to the multiple regulators and/or multiple charging ICs is reduced.

In another configuration, a power supply temperature is sensed. For example, a digital interface to the power supply cable can enable the sensing. That is, a power supply heat sensor can be coupled to the digital interface. A controller determines when to reduce the charging regulators' input power consumption in order to reduce the power supply's temperature.

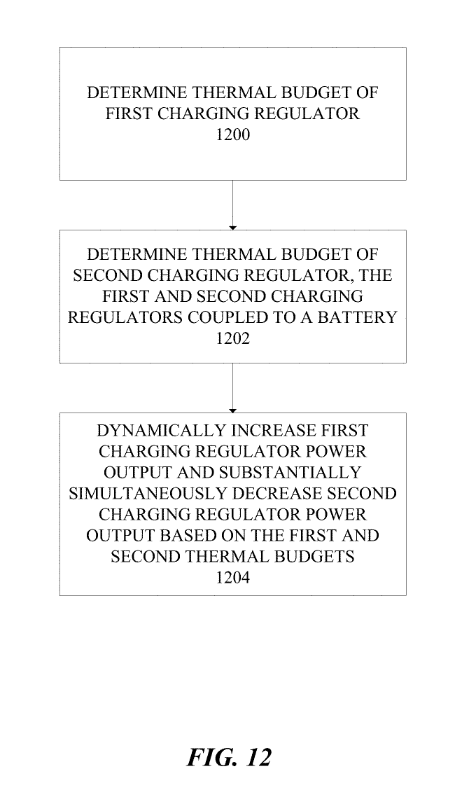

FIG. 12 shows an exemplary thermal balancing process. At block 1200, a first thermal budget for a first charging regulator is determined. The charging regulator can be a voltage or current based regulator. One or more heat sensors can detect an amount of heat at the first charging regulator, which can be compared to the thermal budget based on a predetermined thermal limit or a dynamically determined thermal limit. At block 1202, a thermal budget for a second charging regulator is determined. One or more heat sensors can detect an amount of heat at the second charging regulator, which can be compared to the thermal budget based on a predetermined thermal limit or a dynamically determined thermal limit. The comparison can be performed by a controller (e.g., PMIC). At block 1204, a controller, such as a PMIC, dynamically increases the charging current, voltage and/or power output at the charging regulator in response to no change or a decrease in heat detected at the first charging regulator. The controller also substantially simultaneously decreases the amount of charging current, voltage and/or power output generated at the second charging regulator in response to an increase in heat detected at the second charging regulator.

According to a further aspect of the present disclosure, a power supply apparatus is described. The power supply apparatus includes a first charging regulator and a first heat sensor proximate the first charging regulator. The power supply apparatus also includes a second charging regulator and a second heat sensor proximate the second charging regulator. The power supply apparatus further includes means for dynamically adjusting or means for dynamically increasing the first charging regulator power output and substantially simultaneously decreasing the second charging regulator power output based on information from the first heat sensor and the second heat sensor. Alternatively, the means for adjusting may adjust the second charging regulator power output or the first charging regulator power output or both. The adjusting means (e.g., increasing means) may be the power management integrated circuit (PMIC) shown in FIG. 10. In another aspect, the aforementioned means may be any module or any apparatus configured to perform the functions recited by the aforementioned means.

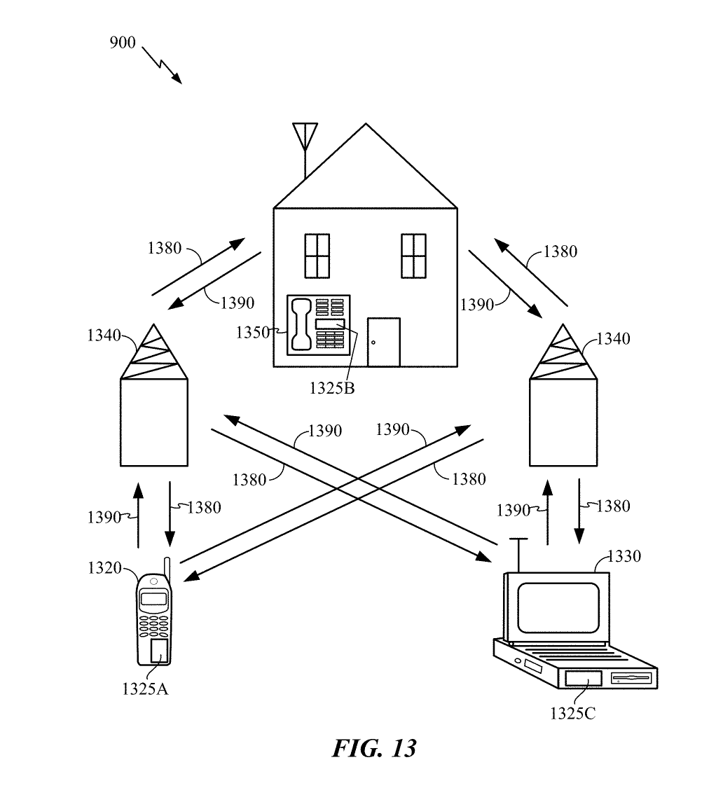

FIG. 13 is a block diagram showing an exemplary wireless communication system 1300 in which a configuration of the disclosure may be advantageously employed. For purposes of illustration, FIG. 13 shows three remote units 1320, 1330, and 1350 and two base stations 1340. It will be recognized that wireless communication systems may have many more remote units and base stations. Remote units 1320, 1330, and 1350 include charging systems 1325A, 1325B, and 1325C, which include the disclosed dynamic thermal balancing. It will be recognized that any device containing an IC may also include the disclosed thermal balancing, including the base stations, switching devices, and network equipment. FIG. 13 shows forward link signals 1380 from the base station 1340 to the remote units 1320, 1330, and 1350 and reverse link signals 1390 from the remote units 1320, 1330, and 1350 to base stations 1340.

In FIG. 13, a remote unit 1320 is shown as a mobile telephone, a remote unit 1330 is shown as a portable computer, and a remote unit 1350 is shown as a fixed location remote unit in a wireless local loop system. For example, the remote units may be a mobile phone, a hand-held personal communication systems (PCS) unit, a portable data unit such as a personal data assistant, a GPS enabled device, a navigation device, a set top box, a music player, a video player, an entertainment unit, a fixed location data unit such as a meter reading equipment, or any other device that stores or retrieves data or computer instructions, or any combination thereof. For example, a remote unit including the thermal balancing may be integrated within a vehicle control system, a server computing system or other like system specifying critical data integrity. Although FIG. 13 illustrates IC devices 1325A, 1325B, and 1325C, which include the disclosed thermal balancing, the disclosure is not limited to these exemplary illustrated units. Aspects of the present disclosure may be suitably employed in any device, which includes thermal balancing.

Charging circuitry in accordance with the present disclosure allows for the parallelizing of multiple battery chargers while reducing power loss and spreading heat to avoid hot spots. Parallel charging performance is improved. For example, heat spreading is achieved by balancing a load (e.g., battery) even when nearby loads/heat sources change, are activated, or deactivated and/or ambient temperature varies. Balancing the load according to aspects of the present disclosure results in faster charging independent of the parallel use case. Furthermore, the aspects of the present disclosure enable a single power management device (e.g., PMIC) to generate optimum or improved output power for a detected or specified skin temperature.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for supplying power to a battery, comprising:
determining a first thermal budget for a first charging regulator;
determining a second thermal budget for a second charging regulator, the first charging regulator and the second charging regulator coupled to the battery; and
dynamically increasing a first charging regulator power output and substantially simultaneously decreasing a second charging regulator power output based at least in part on the first thermal budget and the second thermal budget.

2. The method of claim 1, in which each of the first charging regulator and the second charging regulator controls current in a first mode of operation and controls voltage in another mode of operation.

3. The method of claim 1, in which the first charging regulator and the second charging regulator are in a single integrated circuit (IC).

4. The method of claim 1, in which the first charging regulator is in a first integrated circuit (IC) and the second charging regulator is in a second IC.

5. The method of claim 1, further comprising:
determining a third thermal budget for a third charging regulator that is coupled to the battery; and
dynamically further increasing the first charging regulator power output and substantially simultaneously decreasing a third charging regulator power output based at least in part on the first thermal budget and the third thermal budget.

6. The method of claim 1, in which the first charging regulator comprises a charge pump.

7. The method of claim 1, further comprising:
sensing a temperature of a power supply coupled to inputs of the first charging regulator and the second charging regulator; and
determining whether to reduce an input power consumption of the first charging regulator and/or the second charging regulator based on the sensed temperature.

8. The method of claim 1, further comprising integrating the first charging regulator and the second charging regulator into a mobile phone, a set top box, a music player, a video player, an entertainment unit, a navigation device, a computer, a hand-held personal communication systems (PCS) unit, a portable data unit, and/or a fixed location data unit.

9. A power supplying apparatus, comprising:
a first charging regulator;
at least one first heat sensor proximate the first charging regulator;
a second charging regulator, the first charging regulator and the second charging regulator coupled to a battery to supply power to the battery;
at least one second heat sensor proximate the second charging regulator; and
a controller configured to dynamically increase a first charging regulator power output and substantially simultaneously decrease a second charging regulator power output based at least in part on information from the at least one first heat sensor and the at least one second heat sensor.

10. The power supplying apparatus of claim 9, in which each of the first charging regulator and the second charging regulator controls current in a first mode of operation and controls voltage in another mode of operation.

11. The power supplying apparatus of claim 9, in which the first charging regulator and the second charging regulator are in a single integrated circuit (IC).

12. The power supplying apparatus of claim 9, in which the first charging regulator is in a first integrated circuit (IC) and the second charging regulator is in a second IC.

13. The power supplying apparatus of claim 9, further comprising:
a third charging regulator coupled to the battery to supply power to the battery; and
at least one third heat sensor proximate the third charging regulator;
in which the controller is configured to further increase the first charging regulator power output and substantially simultaneously decrease a third charging regulator power output based at least in part on information for the at least one third heat sensor.

14. The power supplying apparatus of claim 9, in which the first charging regulator comprises a charge pump.

15. The power supplying apparatus of claim 9, further comprising:
a power supply coupled to inputs of the first charging regulator and the second charging regulator; and
a power supply heat sensor coupled to the power supply;
in which the controller is configured to determine whether to reduce an input power consumption of the first charging regulator and/or the second charging regulator based on measurements from the power supply heat sensor.

16. The power supplying apparatus of claim 9, integrated into a mobile phone, a set top box, a music player, a video player, an entertainment unit, a navigation device, a computer, a hand-held personal communication systems (PCS) unit, a portable data unit, and/or a fixed location data unit.

17. A power supplying apparatus, comprising:
a first charging regulator;
a first heat sensor proximate the first charging regulator;
a second charging regulator, the first charging regulator and the second charging regulator coupled to a battery to supply power to the battery;
a second heat sensor proximate the second charging regulator; and
means for dynamically increasing a first charging regulator power output and substantially simultaneously decreasing a second charging regulator power output based at least in part on information from the first heat sensor and the second heat sensor.

18. The power supplying apparatus of claim 17, in which each of the first charging regulator and the second charging regulator controls current in a first mode of operation and controls voltage in another mode of operation.

19. The power supplying apparatus of claim 17, in which the first charging regulator and the second charging regulator are in a single integrated circuit (IC).

20. The power supplying apparatus of claim 17, in which the first charging regulator is in a first integrated circuit (IC) and the second charging regulator is in a second IC.

21. The power supplying apparatus of claim 17, integrated into a mobile phone, a set top box, a music player, a video player, an entertainment unit, a navigation device, a computer, a hand-held personal communication systems (PCS) unit, a portable data unit, and/or a fixed location data unit.
